(19) United States
(12) Patent Application Publication
(10) Pub. No.: US 2012/0182925 A1
(43) Pub. Date: Jul. 19, 2012

(54) SCHEDULING APPARATUS AND METHOD, USER EQUIPMENT, AND RELAY-BASED MOBILE COMMUNICATION SYSTEM

(75) Inventors: Kyung Yul CHEON, Daejeon (KR); Ae Soon PARK, Daejeon (KR); Bum Gon CHOI, Gyeonggi-do (KR); Sueng Jae BAE, Gyeonggi-do (KR); Min Young CHUNG, Seoul (KR)

(73) Assignees: Sungkyunkwan University Foundation for Corporate Collaboration, Gyeonggi-do (KR); Electronics and Telecommunications Research Institute, Daejeon (KR)

(21) Appl. No.: 13/345,925

(22) Filed: Jan. 9, 2012

(30) Foreign Application Priority Data
Jan. 19, 2011 (KR) 10-2011-0005231

(51) Int. Cl. H04W 72/04; H04W 88/04

(52) U.S. Cl. 370/315

(57) ABSTRACT

Provided are a scheduling apparatus and method, an user equipment, and a relay-based mobile communication system. The scheduling apparatus receives information on a channel state of the access zone from the eNB UE separately from the information on the channel state of the relay zone, performs scheduling for the eNB UE in a subsequent relay zone temporally following the relay zone on the basis of the information on the channel state of the relay zone, and performs scheduling for the eNB UE in a subsequent access zone temporally following the access zone on the basis of the information on the channel state of the access zone.

### CLAIM FOR PRIORITY

This application claims priority to Korean Patent Application No. 10-2011-0005231 filed on Jan. 19, 2011 in the Korean Intellectual Property Office (KIPO), the entire contents of which are hereby incorporated by reference.

### BACKGROUND

1. Technical Field

Example embodiments of the present invention relate in general to a relay-based mobile communication network, and a scheduling apparatus, user equipment (UE) and a scheduling method of an evolved node base station (eNB) in the same, and more particularly, to an apparatus and method for allocating radio resources in a relay-based mobile communication network enabling an eNB and a relay node (RN) to dispersively allocate radio resources to UE in a Long Term Evolution (LTE)-Advanced mobile communication network.

2. Related Art

A relay station (RS) is an apparatus serving as a repeater that connects an eNB and UE. As illustrated in FIGS. 1(A) and 1(B), RSs are installed in a shaded area and cell boundary to effectively extend cell coverage and increase throughput without adding a new eNB or wired backhaul.

FIG. 1(A) shows a model of RS utilization that can be extended in coverage using an RS. Specifically, FIG. 1(A) shows a case in which an RS is installed at or outside a cell edge of a donor eNB and provides service to terminals outside a cell radius of the eNB, and cases in which RSs relay a signal of the eNB to terminals on the opposite side of the eNB with respect to a forest of buildings, terminals among buildings, terminals in a building having a poor wireless environment, and terminals in a subway train.

FIG. 1(B) shows a model of RS utilization in which cell throughput is improved using an RS. RSs 200-1 and 200-2 shown in FIG. 1(B) are within a cell radius of a donor eNB 100 and provide terminals present around a cell boundary with better quality service compared to a case with no RS. Specifically, while terminal 1 300-1 having no RS between the eNB 100 and terminal 1 300-1 itself is provided with a low-transmission-rate link, for example, a quadrature phase-shift keying (QPSK) link, RSs receive data from the eNB 100 and transmit the data to terminal 2 300-2 and terminal 3 300-3 present in cell radiuses of the RSs at a high transmission rate such as 64 quadrature amplitude modulation (QAM) transmission rate, so that cell throughput can be improved.

However, in existing resource allocation schemes in a relay-based network, scheduling is performed without considering a signal-to-interference-plus-noise ratio (SINR) difference between a relay zone, in which an eNB communicates with an RS or terminal through an RS link or direct link, and an access zone, in which an eNB and RS communicate with UE using a direct link and access link. Consequently, radio resources of the RS zone and access zone are not efficiently used, and a solution to this problem is necessary.

### SUMMARY

Accordingly, example embodiments of the present invention are provided to substantially obviate one or more problems due to limitations and disadvantages of the related art.

Example embodiments of the present invention provide a radio resource allocation apparatus and method in a relay-based mobile communication network causing evolved node base station (eNB) user equipment (UE) to report respective channel states of a relay zone and access zone, and an eNB to perform additional scheduling according to the respective channel states.

In some example embodiments, a scheduling apparatus in a relay-based mobile communication system having a frame structure including a relay zone in which an evolved node base station (eNB) communicates with a relay node (RN) or an eNB user equipment (UE) served by the eNB, and an access zone in which the eNB and the RN communicate with the eNB UE and relay UE (RUE) respectively, receives information on a channel state of the relay zone from the eNB UE, receives information on a channel state of the access zone from the eNB UE separately from the information on the channel state of the relay zone, performs scheduling for the eNB UE in a subsequent relay zone temporally following the relay zone on the basis of the information on the channel state of the relay zone, and performs scheduling for the eNB UE in a subsequent access zone temporally following the access zone on the basis of the information on the channel state of the access zone.

The scheduling may be performed using a proportional fairness (PF) algorithm. The scheduling may be performed so that a probability of radio resources being allocated to the eNB UE in the subsequent relay zone becomes higher than a probability of radio resources being allocated to the eNB UE in the subsequent access zone as a difference between the channel state of the relay zone and the channel state of the access zone increases.

The scheduling apparatus may be present in the eNB.

In other example embodiments, UE operating in a relay-based mobile communication system having a frame structure including a relay zone in which an evolved node base station (eNB) communicates with a relay node (RN) or an eNB user equipment (UE) served by the eNB, and an access zone in which the eNB and the RN communicate with the eNB UE and RUE respectively, transmits information on a channel state of a first relay zone to the eNB, and transmits information on a channel state of a first access zone to the eNB separately from the information on the channel state of the first relay zone.

The UE may be the eNB UE not served by the RN but served by the eNB.

Transmission of the information on the channel state of the first relay zone and the information on the channel state of the first access zone may be performed in a second relay zone temporally following the first relay zone and a second access zone temporally following the first access zone, respectively.

In other example embodiments, a scheduling method of an eNB in a relay-based mobile communication system having a frame structure including a relay zone in which an evolved node base station (eNB) communicates with a relay node (RN) or an eNB user equipment (UE) served by the eNB, and an access zone in which the eNB and the RN communicate with the eNB UE and RUE respectively, includes: receiving information on a channel state of a first relay zone from the eNB UE; receiving information on a channel state of a first access zone from the eNB UE separately from the information on the channel state of the first relay zone; performing scheduling for the eNB UE in a subsequent relay zone temporally following the first relay zone on the basis of the information on the channel state of the first relay zone; and performing scheduling for the eNB UE in a subsequent access zone temporally following the first access zone on the basis of the information on the channel state of the first access zone.

The scheduling method may further include transmitting data to the eNB UE according to the scheduling for the eNB UE in the subsequent relay zone and the scheduling for the eNB UE in the subsequent access zone. At this time, a modulation and coding scheme (MCS) level applied to the transmission in the subsequent relay zone may be set to be higher than an MCS level applied to the transmission in the subsequent access zone.

The scheduling method may further comprising performing scheduling for a third relay zone temporally following a second relay zone temporally following the first relay zone in a second access zone. Here, the receiving of the information on the channel state of the first relay zone from the eNB UE is performed in the second relay zone, and the receiving of the information on the channel state of the first access zone from the eNB UE separately from the information on the channel state of the first relay zone is performed in the second access zone temporally following the first access zone.

The scheduling method may further include: receiving a channel state report on the first relay zone from the RN communicating with the eNB in the second relay zone; performing scheduling for the third relay zone in the second access zone according to the channel state report on the first relay zone received from the RN; and transmitting data to the RN in the third relay zone according to the scheduling results for the third relay zone.

In other example embodiments, a relay-based mobile communication system having a frame structure including a relay zone in which an evolved node base station (eNB) communicates with a relay node (RN) or an eNB user equipment (UE) served by the eNB, and an access zone in which the eNB and the RN communicate with the eNB UE and RUE respectively, includes: the eNB configured to receive information on a channel state of the relay zone from the eNB UE, receive information on a channel state of the access zone from the eNB UE separately from the information on the channel state of the relay zone, perform scheduling for the eNB UE in a subsequent relay zone temporally following the relay zone on the basis of the information on the channel state of the relay zone, and perform scheduling for the eNB UE in a subsequent access zone temporally following the access zone on the basis of the information on the channel state of the access zone; and the RN configured to receive a channel state report on the access zone from the RUE, and perform scheduling for the RUE on the basis of the channel state report on the access zone received from the RUE.

The relay-based mobile communication system may further include: the eNB UE configured to transmit the information on the channel state of the relay zone to the eNB, and transmit the information on the channel state of the access zone to the eNB separately from the information on the channel state of the relay zone; and the RUE configured to transmit the information on the channel state of the access zone to the RN.

### BRIEF DESCRIPTION OF DRAWINGS

Example embodiments of the present invention will become more apparent by describing in detail example embodiments of the present invention with reference to the accompanying drawings, in which:

FIG. 1(A) shows a model of relay station (RS) utilization that can be extended in coverage using an RS;

FIG. 1(B) shows a model of RS utilization in which cell throughput is improved using an RS;

FIG. 2 shows components of a relay-based mobile communication network according to an example embodiment of the present invention;

FIG. 3 shows an example embodiment of a time division duplex (TDD) frame structure of a Long Term Evolution (LTE)-Advanced system to which radio resource allocation according to the present invention is applied;

FIG. 4 shows an example embodiment of a frame structure including a relay zone and access zone to which radio resource partitioning according to the present invention is applied;

FIG. 5 illustrates an example of interference in a relay zone and access zone;

FIG. 6 is a flowchart illustrating a relation between channel quality indication (CQI) reports and scheduling time points;

FIG. 7 is a flowchart illustrating operation of evolved node base station (eNB) user equipment (UE) according to an example embodiment of the present invention; and

FIG. 8 is a flowchart illustrating operation of an eNB according to an example embodiment of the present invention.

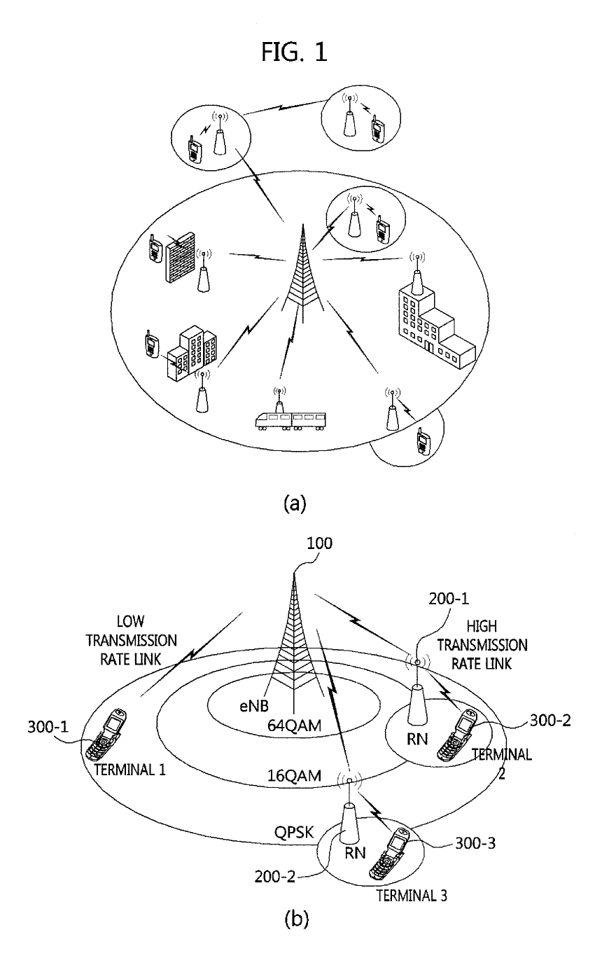

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “user equipment (UE)” used herein may be referred to as a mobile station (MS), user terminal (UT), wireless terminal, access terminal (AT), terminal, subscriber unit, subscriber station (SS), wireless device, wireless communication device, wireless transmit/receive unit (WTRU), moving node, mobile, or other tell is. Various example embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited to these.

The term “evolved node base station (eNB)” used herein generally denotes a fixed point communicating with a terminal, and may be referred to as a base station, Node-B, base transceiver system (BTS), access point (AP), and other terms.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, example embodiments of the present invention will be described in detail with reference to the appended drawings. To aid in understanding the present invention, like numbers refer to like elements throughout the description of the figures, and the description of the same component will not be reiterated.

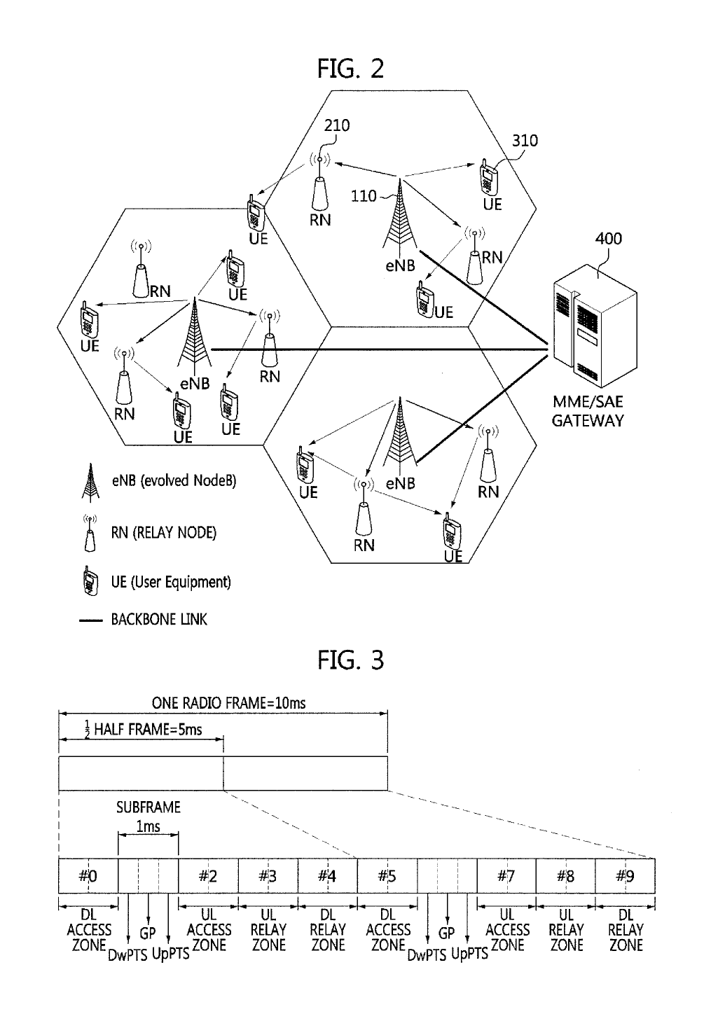

FIG. 2 shows components of a relay-based mobile communication network according to an example embodiment of the present invention.

The example embodiment shown in FIG. 2 is a network including a relay node (RN) defined in Long Term Evolution (LTE)-Advanced among mobile communication networks. As shown in FIG. 2, a relay-based network defined in LTE-Advanced may include an eNB 110, an RN 210, UE 310, and a mobility management entity (MME)/system architecture evolution (SAE) gateway 400.

The MME/SAE gateway 400 performs transmission of a control signal, security control, bearer management, roaming service, user authentication, management of user mobility, and so on. The eNB 110 constitutes an evolved universal terrestrial radio access network (E-UTRAN) to perform a radio resource management (RRM) function, and serves to transfer user-plane information to the gateway 400. The RN 210 is present between the UE 310 and the eNB 110, and serves to transfer data received from the eNB 110 or the UE 310 through a wireless link to a destination.

In a relay-based network, wireless links are classified into eNB-RN links (referred to as “relay links”), eNB-UE links (referred to as “direct links”), and RN-UE links (referred to as “access links”). The UE 310 may perform communication with the eNB110 through a direct link or by way of the RN 210.

In LTE-Advanced, inband relay in which a relay link and access link share the same frequency has been defined. Inband relay denotes a case in which a link between a relay and an eNB share the same band with a link between the eNB and a terminal. On the other hand, outband relay denotes a case in which a link between an eNB and an RN does not operate in the same band as a link between the eNB and a terminal.

Due to characteristics of inband relay, an RN cannot simultaneously perform data reception from an eNB and data transmission to UE. Thus, to support relay in LTE-Advanced, a time-division-based relay frame structure whereby a relay link and access link are activated at different times needs to be defined. In LTE-Advanced standards, a time division duplex (TDD) frame structure as shown in FIG. 3 has been defined as such a supporting frame structure.

FIG. 3 shows an example embodiment of a TDD frame structure of an LTE-Advanced system to which radio resource allocation according to the present invention is applied.

An LTE-Advanced system has a frame structure consisting of radio frames having a period of 10 ms for downlink and uplink transmission, and supports both of a frequency division duplex (FDD) frame structure and a TDD frame structure.

In a frame structure for FDD, one radio frame having a length of 10 ms is equally divided into 10 subframes, and each of the subframes has two slots of the same size. In the FDD frame structure, 10 subframes are valid for each of an uplink and downlink at periods of 10 ms. Uplink transmission and downlink transmission are performed through separate frequency domains.

As another frame structure, a TDD structure is as shown in FIG. 3.

Each radio frame having a length of 10 ms consists of two half (½) frames each having a length of 5 ms, and has three particular fields of Downlink Pilot Time Slot (DwPTS), Uplink Pilot Time Slot (UpPTS), and Guard Period (GP). Lengths of DwPTS and UpPTS may be subordinate to the total length (1 ms) of DwPTS, GP and UpPTS. An LTE-Advanced TDD structure support both structures having a 5-ms switch-point period and a 10-ms switch-point period, and the TDD frame structure of FIG. 3 has the 5-ms switch-point period.

In the structure having the 5-ms switch-point period as shown in FIG. 3, subframe 1 and subframe 6 have switch points consisting of DwPTS, GP and UpPTS. Also, GP that is a time for switchover between a downlink and uplink is provided in a TDD frame structure as shown in FIG. 3.

In the frame structure of FIG. 3, relay zones are sections in which an eNB communicates with an RN or UE through a relay link or direct link, and access zones are sections in which the eNB and RN communicate with UE through a direct link and access link.

Meanwhile, the frame structure shown in FIG. 3 is merely an example embodiment of a frame structure to which the present invention can be applied, and relay-supporting TDD frame structures of LTE-Advanced include the structure shown in FIG. 3 and various other frame structures as well.

Although FIG. 3 shows the TDD frame structure as an example embodiment to which the present invention is applied, the present invention can be applied not only to a TDD frame structure but also to a mobile communication system having an FDD frame structure.

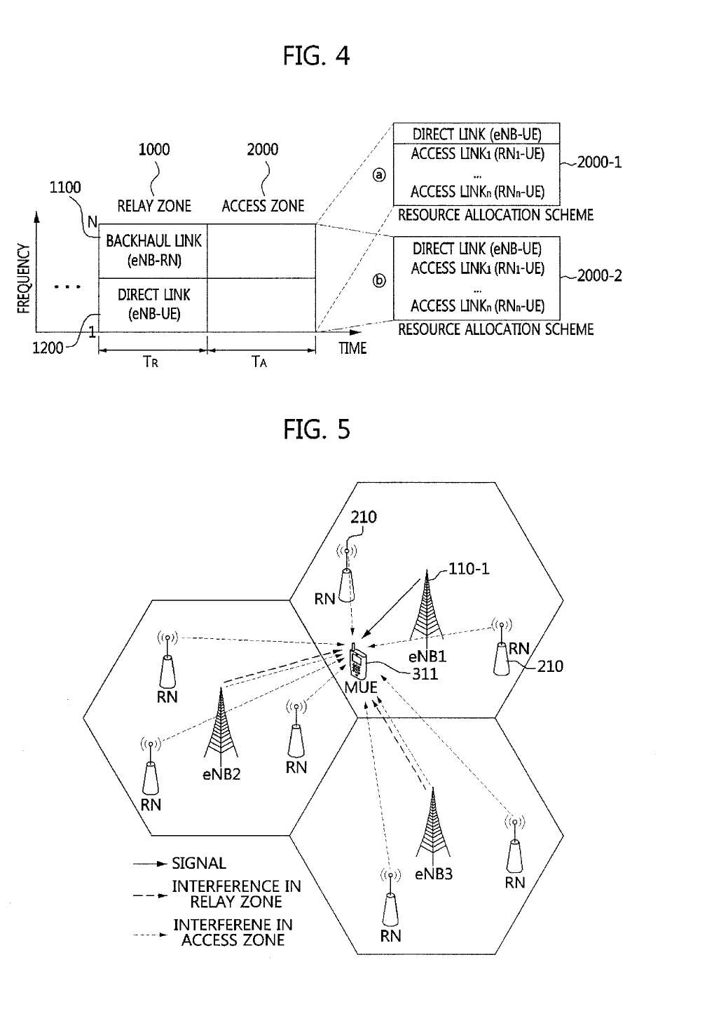

FIG. 4 shows an example embodiment of a frame structure including a relay zone and access zone to which radio resource partitioning according to the present invention is applied.

A frame structure shown in FIG. 4 includes a relay zone 1000 and an access zone 2000. The relay zone 1000 includes a backhaul link 1100 between an eNB and an RN, and a direct link 1200 between an eNB and macro UE (MUE; or eNB UE) connecting to the eNB.

As shown in FIG. 4, the direct link 1200 and the relay link 1100 use different sub-channels in the relay zone 1000. However, the access zone 2000 may be classified as access zone 1 2000-1 in which the direct link 1200 and an access link use different sub-channels, or access zone 2 2000-2 in which all sub-channels are reused. In other words, the access zone 2000 may be access zone 1 2000-1 or access zone 2 2000-2.

Here, when the direct link 1200 and the access link use different sub-channels in the access zone 2000, inter-link interference does not occur. Thus, the UE experiences a high signal-to-interference-plus-noise ratio (SINR), but the overall network capacity reduces due to a reduction in the number of sub-channels that can be used by the eNB and RN. On the other hand, when the eNB and RN reuse the sub-channels in the access zone 2000, the eNB and RN interfere with each other. Thus, an SINR of each sub-channel is reduced, but network capacity increases due to an increase in the number of sub-channels that can be used by the eNB and RN.

When the eNB and RN reuse the sub-channels, a reception SINR that the MUE communicating with the eNB through the direct link 1200 experiences in the relay zone 1000 and the access zone 2000 varies due to interference between the eNB and RN.

A time frame of a relay-based LTE-Advanced network according to example embodiments of the present invention assumes the case of access zone 2 2000-2 of FIG. 4. In a relay zone of such a frame structure, an eNB may transmit data to an RN or UE using different sub-channels, and in an access zone, the eNB and RN may transmit data to the UE using all sub-channels.

FIG. 5 illustrates an example of interference in a relay zone and access zone.

The example of interference shown in FIG. 5 assumes the case of access zone 2 2000-2 shown in FIG. 4. In an access zone of such a frame structure, an eNB and RN may transmit data to UE by reusing all sub-channels.

In FIG. 5, it is assumed that eNB1 110-1 transmits a signal to MUE 311 while controlling the MUE 311. At this time, the MUE 311 may receive signals transmitted by eNB 2 and eNB 3 of adjacent cells and at least one RN present around the MUE 311 as well as the signal transmitted by eNB 1 110-1. A signal received from an adjacent cell eNB or surrounding RNs acts as interference to the MUE 311.

FIG. 5 shows that the amounts of interference received by the MUE 311 in a relay zone and access zone become different from each other. This is because while an eNB transmits data to an RN or UE using different sub-channels in a relay zone, the eNB and RN transmit data to the UE by reusing all sub-channels in an access zone. In other words, interference received by the MUE 311 in a relay zone is caused only by signals received from an adjacent eNB, but interference received by the MUE 311 in an access zone is caused by signals received from surrounding RNs as well as the adjacent eNB. As a result, the relay zone having less interference has a greater reception SINR than the access zone.

In an example embodiment of the present invention in this situation, the MUE 311 separately reports channel quality indications (CQIs) of a relay zone and access zone to allocate resources in consideration of reception SINRs experienced in the relay zone and access zone.

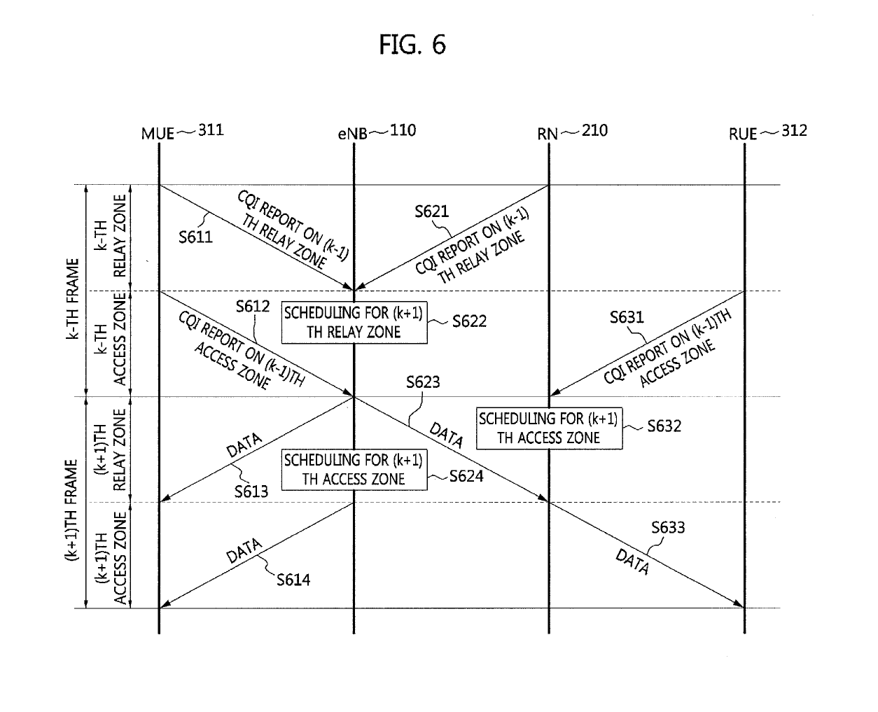

FIG. 6 is a flowchart illustrating a relation between CQI reports and scheduling time points.

Detailed operation performed by an eNB and RN in a relay zone and access zone of a frame structure according to example embodiments of the present invention is as follows.

The flowchart shown in FIG. 6 illustrates a flow of operations for a k-th frame, which is an arbitrary frame, among an eNB, eNB UE, RN, and relay UE (RUE) in a frame structure including successive frames in order of time from an upper portion of a vertical axis to a lower portion.

FIG. 6 illustrates operation in a relay zone and access zone included in each of k-th and (k+1)th frames. Detailed description of operations (S611, S621, S614, S633, etc.) shown for a repeated structure will be omitted, and for convenience, description will be made focusing on operation in a k-th access zone and operation in a (k+1)th relay zone.

Operation in k-th Access Zone

First, an eNB 110 receives information on a (k−1)th access zone, particularly, CQI information on a direct link channel state of the access zone, reported by MUE 311 (S612). At the same time, the eNB 110 allocates radio resources to the MUE 311 according to resource allocation results determined in a k-th relay zone (not shown). The eNB 110 performs scheduling for resource allocation in the (k+1)th relay zone on the basis of CQI information on the MUE 311 and an RN 210 collected in the k-th relay zone (S622). Here, in an example embodiment of the present invention, the scheduling is performed using a proportional fairness (PF) algorithm.

A scheduling method according to an example embodiment of the present invention will be described in detail below.

When a direct link between an eNB and a terminal and an access link between an RN and the terminal share common frequency resources as in access zone 2 2000-2 of FIG. 4, a scheduling algorithm is needed. In other words, considering characteristics of current mobile communication systems evolved from a structure of several dedicated channels into a structure of one large common channel, the concept of scheduling, which is a question of how much resources are allocated to whom at a specific point in time, comes into the limelight. Thus, the overall performance of a system may depend on the superiority of a scheduling algorithm.

To determine a scheduling algorithm, system capacity, efficiency, whether or not different types and levels of quality of service (QoS) can be supported according to different service applications, etc. need to be considered. A scheduling algorithm applied to an example embodiment of the present invention utilizes the PF algorithm. The PF algorithm is an algorithm that can satisfy both efficiency and fairness. Since it is impossible to maximize both efficiency and fairness, the PF algorithm makes an appropriate trade-off between efficiency and fairness.

In general, the PF algorithm uses a PF metric consisting of a numerator and denominator. The numerator denotes a current channel state of a caller, and the denominator denotes a moving average of data rates that have been previously provided to respective callers. In other words, the better the channel state of the callers, the greater a final PF metric value, and the higher a probability of being allocated resources. If the caller has been previously provided with much resources, a final PF metric value is reduced, and if the caller has not been provided with resources for a long time, a final PF metric value increases. In brief, by appropriately adjusting two goals of pursuing efficiency through the numerator of a PF metric and pursuing fairness through the denominator, it is possible to ensure proper fairness as well as high system throughput.

An example embodiment of the present invention uses the PF algorithm as a scheduling algorithm. In Table 1 below, symbols used in example embodiments of the present invention are described.

TABLE 1

| Symbol | Meaning |
|---|---|
| M_{n,j}^{RZ}(k) | PF metric of UE j for sub-channel n in k-th relay zone |
| Mₙⱼ^{AZ}(k) | PF metric of UE j for sub-channel n in k-th access zone |
| E_{n,j}^{RZ,d}(k) | Frequency efficiency of UE j direct link for sub-channel n received in k-th relay |
| | zone |
| E_{n,i}^{RZ,b}(k) | Frequency efficiency of relay link of RN i for sub-channel n received in k-th |
| | relay zone |
| E_{n,j}^{AZ,d}(k) | Frequency efficiency of UE j direct link for sub-channel n received in k-th |
| | access zone |
| E_{n,j}^{AZ,a}(k) | Frequency efficiency of UE j access link for sub-channel n received in k-th |
| | access zone |
| R_{i,j}^{RN}(k) | Data transmission rate of RN i for UE j in k-th relay zone |
| Rⱼ(k) | Data transmission rate of UE j in k-th frame |

Returning to S622, a scheduling method used in S622 will be described. In S622, a PF metric for sub-channel n of MUE j connecting to an eNB in a (k+1)th relay zone and a PF metric for sub-channel n of UE (referred to as RUE) 1 connecting to RN i in the (k+1)th relay zone are calculated according to Equation (1) and Equation (2) below.

$$\begin{matrix}{M}_{n , j}^{RZ} ( k + 1 ) = \frac{{E}_{n , j}^{RZ , d} ( k )}{{\overline{R}}_{j} ( k )} & ( 1 ) \\ {M}_{n , l}^{RZ} ( k + 1 ) = \frac{{E}_{n , i}^{RZ , b} ( k )}{{\overline{R}}_{i , l}^{RN} ( k )} & ( 2 )\end{matrix}$$

Here, R̅ᵢ(k) and R̅_{i,l}^{RN}(k) are an average data transmission rate of RUE l at which reception has been made by MUE j or RN i, and may be calculated according to Equation (3) and Equation (4) below.

$$\begin{matrix}{\overline{R}}_{j} ( k ) = ( 1 - \frac{1}{{T}_{c}} ) {\overline{R}}_{j} ( k - 1 ) + \frac{1}{{T}_{c}} {R}_{k} ( k ) & ( 3 ) \\ {\overline{R}}_{i , l}^{RN} ( k ) = ( 1 - \frac{1}{{T}_{c}} ) {\overline{R}}_{i , l}^{RN} ( k - 1 ) + \frac{1}{{T}_{c }} {R}_{i , l}^{RN} ( k ) & ( 4 )\end{matrix}$$

Here, T_{c} denotes a window size set to calculate an average.

Meanwhile, the RN 210 allocates radio resources to RUE 312 to which it is connected according to scheduling results determined in the k-th relay zone, and collects CQI information on a channel state of the (k−1)th access zone reported by the RUE 312 (S631).

Operation in (k+1)th Relay Zone

The eNB 110 collects CQI information on a channel state of the k-th relay zone reported by the RN 210 and the MUE 311 for scheduling for a (k+2)th relay zone (not shown), and allocates radio resources, that is, transmits data, to the RN 210 or the MUE 311 according to scheduling results determined in a k-th access zone (S613 and S623). At the same time, the eNB 110 calculates PF metrics according to respective sub-channels of the MUE 311 and performs scheduling for a (k+1)th access zone (S624).

Here, a PF metric for sub-channel n of UE j may be calculated according to Equation (5) below.

$${M}_{n , j}^{AZ} ( k + 1 ) = \frac{{E}_{n , j}^{AZ , d} ( k )}{{R}_{j} ( k )} \qquad ( 5 )$$

Here, comparison will be made between the PF metric for MUE in a relay zone of Equation (1) and the PF metric for MUE in an access zone of Equation (5).

As illustrated in FIG. 5, interference in an access zone is greater than interference in a relay zone. Thus, in comparison with Equation (5), Equation (1) may have a greater numerator of a PF metric working as a frequency efficiency factor, resulting in a strong possibility of Equation (1) having a greater value of the PF metric than Equation (5). In other words, it becomes quite probable that an eNB will allocate radio resources of the relay zone rather than radio resource of the access zone to MUE having a great difference between a channel state of the relay zone and a channel state of the access zone.

Meanwhile, in the (k+1)th relay zone, the RN 210 reports CQI information on a channel state measured in the k-th relay zone to the eNB 110 (not shown). Also, on the basis of CQI information collected in the k-th access zone, the RN 210 calculates PF metrics according to sub-channels of the RUE 312 connected with the RN 210 and performs scheduling for the (k+1)th access zone (S632).

Here, a PF metric for sub-channel n of UE j in the (k+1)th access zone may be expressed as in Equation (6) below.

$${M}_{n , j}^{AZ} ( k + 1 ) = \frac{{E}_{n , j}^{AZ , a} ( k )}{{R}_{j} ( k )} \qquad ( 6 )$$

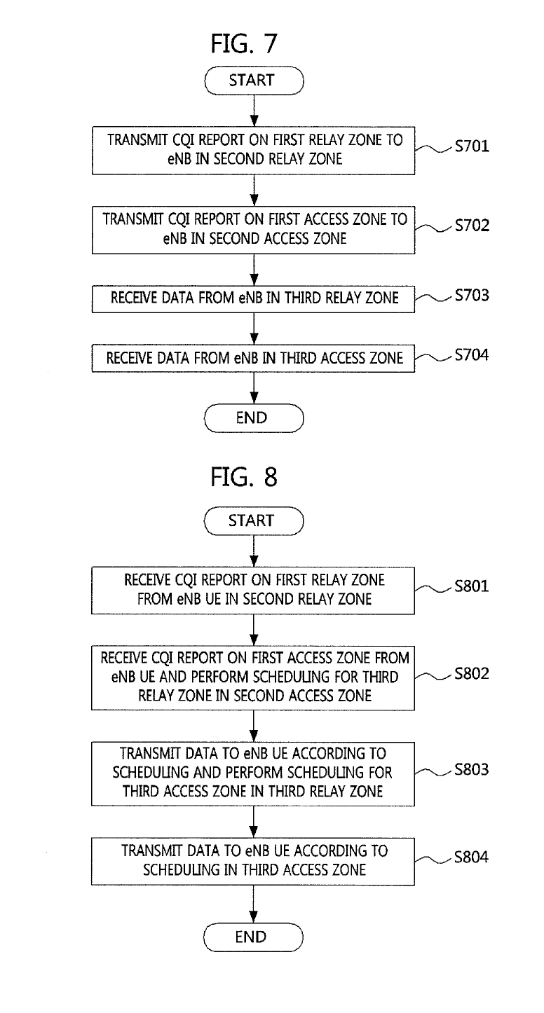

FIG. 7 is a flowchart illustrating operation of eNB UE according to an example embodiment of the present invention.

FIG. 7 illustrates operation of an eNB in the flowchart of FIG. 6 illustrating a relation between CQI reports and scheduling time points.

A first relay zone or first access zone mentioned in FIG. 7 denotes a relay zone or access zone in a successive frame structure. A second relay zone is a time zone temporally following the first relay zone, and a second access zone is a time zone temporally following the first access zone.

eNB UE measures channel quality of a direct link between an eNB and the eNB UE in a first relay zone, and transmits a CQI report on the first relay zone to the eNB in a second relay zone (S701). Also, the eNB UE measures channel quality of the direct link between the eNB and the eNB UE in a first access zone, and transmits a CQI report on the first access zone to the eNB in a second access zone (S702). According to scheduling of the eNB dependent on the CQI report on the first relay zone transmitted in the second relay zone, the eNB UE receives data from the eNB in a third relay zone (S703). According to scheduling of the eNB dependent on the CQI report on the first access zone transmitted in the second access zone, the eNB UE receives data from the eNB in a third access zone (S704).

Although FIG. 7 illustrates an example embodiment of the present invention employing a frame structure in which a first relay zone is temporally followed by a first access zone, the present invention does not exclude an example embodiment employing a frame structure in which an access zone precedes a relay zone. In other words, it is easy to deduce an example embodiment of eNB UE transmitting a CQI report on a first access zone prior to a CQI report on a first relay zone in a structure in which the first access zone temporally precedes the first relay zone, from the example embodiment illustrated in FIG. 7.

FIG. 8 is a flowchart illustrating operation of an eNB according to an example embodiment of the present invention.

FIG. 8 illustrates operation of an eNB focused on a relation with eNB UE in the flowchart of FIG. 6 illustrating a relation between CQI reports and scheduling time points. In other words, the eNB is connected with an RN as shown in FIG. 6 and performs operations of receiving a CQI report from the RN in a relay zone, etc., but FIG. 8 is illustrated focusing on the relation with the eNB UE served by the eNB for convenience.

A first relay zone or first access zone mentioned in FIG. 8 denotes a relay zone or access zone in a successive frame structure. A second relay zone is a time zone temporally following the first relay zone, and a second access zone is a time zone temporally following the first access zone. Also, a third relay zone is a time zone temporally following the second relay zone, and a third access zone is a time zone temporally following the second access zone.

First, an eNB receives a CQI report on a first relay zone from eNB UE in a second relay zone (S801). In a second access zone, the eNB receives a CQI report on a first access zone from the eNB UE, and simultaneously performs scheduling for a third relay zone on the basis of the CQI report on the first relay zone (S802). In the third relay zone, the eNB transmits data to the eNB UE according to the scheduling for the third relay zone, and simultaneously performs scheduling for a third access zone (S803). In the third access zone, the eNB transmits data to the eNB according to the scheduling for the third access zone (S804).

Although FIG. 8 illustrates an example embodiment of the present invention employing a frame structure in which a first relay zone is temporally followed by a first access zone, the present invention does not exclude an example embodiment employing a frame structure in which an access zone precedes a relay zone. In other words, it is easy to deduce an example embodiment of an eNB receiving a CQI report on a first access zone prior to a CQI report on a first relay zone in a structure in which the first access zone temporally precedes the first relay zone, from the example embodiment illustrated in FIG. 8.

In example embodiments of the present invention, an eNB and RN perform scheduling using only channel state information on UE to which they are connected. Thus, the eNB or RN does not need to be notified of a CQI of UE to which it is not connected, and the load of transferring CQI information is reduced.

Also, eNB UE connected with an eNB separately reports CQI information in a relay zone and access zone, and with this taken into consideration, the eNB performs scheduling. Thus, it is possible to transmit data to eNB UE, whose channel state in the access zone is poor, in the relay zone at a higher MCS level than in the access zone, and entire radio resources can be efficiently used.

While the example embodiments of the present invention and their advantages have been described in detail, it should be understood that various changes, substitutions and alterations may be made herein without departing from the scope of the invention.

What is claimed is:

1. A scheduling apparatus in a relay-based mobile communication system having a frame structure including a relay zone in which an evolved node base station (eNB) communicates with a relay node (RN) or an eNB user equipment (UE) served by the eNB, and an access zone in which the eNB and the RN communicate with the eNB UE and relay UE (RUE) respectively, wherein information on a channel state of the relay zone is received from the eNB UE,
information on a channel state of the access zone is received from the eNB UE separately from the information on the channel state of the relay zone,
scheduling for the eNB UE is performed in a subsequent relay zone temporally following the relay zone on the basis of the information on the channel state of the relay zone, and
scheduling for the eNB UE is performed in a subsequent access zone temporally following the access zone on the basis of the information on the channel state of the access zone.

2. The scheduling apparatus of claim 1, wherein the scheduling is performed using a proportional fairness (PF) algorithm.

3. The scheduling apparatus of claim 1, wherein the scheduling is performed so that a probability of radio resources being allocated to the eNB UE in the subsequent relay zone becomes higher than a probability of radio resources being allocated to the eNB UE in the subsequent access zone as a difference between the channel state of the relay zone and the channel state of the access zone increases.

4. The scheduling apparatus of claim 1, wherein the scheduling apparatus is present in the eNB.

5. User equipment (UE) operating in a relay-based mobile communication system having a frame structure including a relay zone in which an evolved node base station (eNB) communicates with a relay node (RN) or an eNB user equipment (UE) served by the eNB, and an access zone in which the eNB and the RN communicate with the eNB UE and relay UE (RUE) respectively, wherein information on a channel state of a first relay zone is transmitted to the eNB, and
information on a channel state of a first access zone is transmitted to the eNB separately from the information on the channel state of the first relay zone.

6. The UE of claim 5, wherein the UE is the eNB UE not served by the RN but served by the eNB.

7. The UE of claim 5, wherein transmission of the information on the channel state of the first relay zone and the information on the channel state of the first access zone is performed in a second relay zone temporally following the first relay zone and a second access zone temporally following the first access zone, respectively.

8. A scheduling method of an evolved node base station (eNB) in a relay-based mobile communication system having a frame structure including a relay zone in which the eNB communicates with a relay node (RN) or an eNB user equipment (UE) served by the eNB, and an access zone in which the eNB and the RN communicate with the eNB UE and relay UE (RUE) respectively, the method comprising:
receiving information on a channel state of a first relay zone from the eNB UE;
receiving information on a channel state of a first access zone from the eNB UE separately from the information on the channel state of the first relay zone;
performing scheduling for the eNB UE in a subsequent relay zone temporally following the first relay zone on the basis of the information on the channel state of the first relay zone; and
performing scheduling for the eNB UE in a subsequent access zone temporally following the first access zone on the basis of the information on the channel state of the first access zone.

9. The scheduling method of claim 8, wherein the scheduling is performed using a proportional fairness (PF) algorithm.

10. The scheduling method of claim 8, wherein the scheduling is performed so that a probability of radio resources being allocated to the eNB UE in the subsequent relay zone becomes higher than a probability of radio resources being allocated to the eNB UE in the subsequent access zone as a difference between the channel state of the first relay zone and the channel state of the first access zone increases.

11. The scheduling method of claim 8, further comprising transmitting data to the eNB UE according to the scheduling for the eNB UE in the subsequent relay zone and the scheduling for the eNB UE in the subsequent access zone,
wherein a modulation and coding scheme (MCS) level applied to the transmission in the subsequent relay zone is higher than an MCS level applied to the transmission in the subsequent access zone.

12. The scheduling method of claim 8, further comprising performing scheduling for a third relay zone temporally following a second relay zone in a second access zone,
wherein the receiving of the information on the channel state of the first relay zone from the eNB UE is performed in the second relay zone temporally following the first relay zone, and
the receiving of the information on the channel state of the first access zone from the eNB UE separately from the information on the channel state of the first relay zone is performed in the second access zone temporally following the first access zone.

13. The scheduling method of claim 12, further comprising:
receiving a channel state report on the first relay zone from the RN communicating with the eNB in the second relay zone;
performing scheduling for the third relay zone in the second access zone according to the channel state report on the first relay zone received from the RN; and
transmitting data to the RN in the third relay zone according to the scheduling results for the third relay zone.

14. A relay-based mobile communication system having a frame structure including a relay zone in which an evolved node base station (eNB) communicates with a relay node (RN) or an eNB user equipment (UE) served by the eNB, and an access zone in which the eNB and the RN communicate with the eNB UE and relay UE (RUE) respectively, the system comprising:
the eNB configured to receive information on a channel state of the relay zone from the eNB UE, receive information on a channel state of the access zone from the eNB UE separately from the information on the channel state of the relay zone, perform scheduling for the eNB UE in a subsequent relay zone temporally following the relay zone on the basis of
the information on the channel state of the relay zone, and perform scheduling for the eNB UE in a subsequent access zone temporally following the access zone on the basis of the information on the channel state of the access zone: and
the RN configured to receive a channel state report on the access zone from the RUE, and perform scheduling for the RUE on the basis of the channel state report on the access zone received from the RUE.

15. The relay-based mobile communication system of claim 14, further comprising:
the eNB UE configured to transmit the information on the channel state of the relay zone to the eNB, and transmit the information on the channel state of the access zone to the eNB separately from the information on the channel state of the relay zone; and
the RUE configured to transmit the information on the channel state of the access zone to the RN.

16. The relay-based mobile communication system of claim 14, wherein the eNB transmits data to the eNB UE according to the scheduling for the eNB UE in the subsequent relay zone and the scheduling for the eNB UE in the subsequent access zone,
wherein a modulation and coding scheme (MCS) level applied to the transmission in the subsequent relay zone is higher than an MCS level applied to the transmission in the subsequent access zone.
